(19) United States
(12) Patent Application Publication
(10) Pub. No.: US 2003/0159322 A1
(43) Pub. Date: Aug. 28, 2003

(54) Information display apparatus

(76) Inventor: Robert W. Mead, Chicago, IL (US)

Correspondence Address: Ronald A. Sandler, Jones, Day, Reavis & Pogue, 77 West Wacker, Chicago, IL, 60601-1692, US

(21) Appl. No.: 10/084,534

(22) Filed: Feb. 28, 2002

(51) Int. Cl. G09F 7/22

(52) U.S. Cl. 40/617

(57) ABSTRACT

A novel display apparatus having a frame with first and second walls for supporting a display sign and the clear sign holder having at least a portion thereof removably associated by self contained fasteners with at least one wall of the frame for covering a display sign that when placed thereunder the sign is held in place against at least one of the walls and can be viewed through the sign holder.

### BACKGROUND OF THE INVENTION

1. Field of the Invention

The present invention relates in general to information display sign holders and, in particular, to a novel frame that holds advertising display material in a manner that it can be readily observed, from both sides if desired, and is constructed such that economically available display material can be quickly and easily removed and replaced.

2. Prior Art

Commercial establishments, such as gas stations retailers, rely heavily on the income from sales of associated convenience stores, auto repair facilities, fast food restaurants, and other profit centers incremental to sales of their general product line, such as gasoline sold at service stations. Since, in the case of gasoline sales, the customer spends a considerable amount of time at the gas pump while fueling a vehicle, it provides an optimal time to provide information and to promote products and services via point of purchase advertising. Today, this advertising consists of “pump topper” advertising signs that actually sit on top of the pump, signs attached to the face of the pump or pump hose, video screens forming a part of the pump, and signs that hang from the ceiling or canopy placed over the pump island or area. These latter signs are typically called “inverted pump toppers” (IPT) because they hang down from the ceiling or canopy placed over the pump island or islands. The IPT that hangs from the ceiling is especially effective because it provides a large advertising area that is easily viewed from standing in front of the pump and because it is also less intrusive in that it opens up the line of vision through the pump area thereby providing a more “open” and less cluttered look to the overall fueling area. The IPT is a bracket system that allows for changeable sign inserts.

Existing IPT's generally consist of a rectangular “open window” type bracket that has an elongated slot in either one of the ends or one of the sides (top and bottom) and is mounted to the ceiling over the pump area or on top of the pumps. If the IPT is to be hung from the canopy or cover over the pump bay, a slot is left in one end of the bracket and the advertising material can be slid into the slot through a recess formed in the top and bottom sides until it reaches the other end of the bracket, which also has a recess in it, and the advertising material is held in place by the recesses in the bracket sides and can be seen through the open area or “window” of the bracket from both sides of the bracket.

Of course, the slot may also be placed in the base of the bracket or frame with the recesses extending down the inside of each end and the top side and the advertising material inserted in the bottom side slot and slid downwardly in the recesses until it reaches the top side. The bracket or frame is then mounted upside down, or in the inverted position. To replace the advertising material, the bracket may be removed from the canopy, the advertising material removed and replaced, and the bracket re-attached to the canopy or ceiling. Alternatively, the advertising material can be removed by opening a non-permanent seal.

If the bracket is mounted on top of the pumps (a “pump topper”), a slot is formed on the top side of the bracket with recesses extending down the inside of each end and the bottom side and the advertising material is inserted in the top side slot and slid downwardly in the recesses until it reaches the bottom side. Again the recesses hold the advertising material, or sign inserts, in place within the bracket. The slot may also be formed in one of the end sides and the advertising sign slid horizontally into the slot.

Their are several disadvantages to the use of such slotted sign inserts. First, the sign insert material must have printing on at least semi-rigid material to keep the wind from blowing the insert out of the bracket. Second, the inserts must be die-cut and press fit into the brackets. Third, the sign inserts are very expensive to print because of the semi-rigid material. Fourth, the signs are difficult to change because of the press fit that is required between the bracket recesses and the at least semi-rigid material. Also, the signs are prone to damage or loss due to the elements such as rain, wind, or other adverse weather conditions. In addition, because the signs are exposed within the open “window” area of the bracket frames, they can be easily vandalized or are subject to tampering.

It should be understood that these signs can be quite large and can be, for instance, of a size such that side edge 18 shown in FIG. 1 at dimension a could be 26⅞″ and common bottom edge 20 at dimension b could be 40″.

It would be advantageous to have an advertising apparatus that could hold a sign insert printed on low cost substrate such as paper, styrene, card stock, and the like that is sheltered from weather elements, easy to change, and better protected from vandalism.

### SUMMARY OF THE INVENTION

The present novel advertising apparatus satisfies the requirements set forth above. It is a combination of both a sign framing system and a sign holder that can be mounted either on the top of the pumps or to the underside of the canopy or ceiling that extends over the pump island as an “inverted pump topper”. The novel frame provides one surface on which the sign is supported and is manufactured from a rigid material such as aluminum, steel, rigid vinyl, high impact plastic, or even wood. In the preferred embodiment, it is formed in a V-shape so as to hang from the canopy ceiling over the pumps, as an IPT, with the faces, or walls, of the “V” hanging downwardly and inwardly and facing in opposite directions transverse to the pumps so that a customer on either side of the pump may view the information or advertising message on the sign. A clear, or transparent, overlay is easily and removably attached to the faces, or walls, over the advertising sign, so that the sign can be viewed through the clear, or transparent, overlay. The attachment means is particularly not easily damaged but simple to use. Moreover, the attachment means may coextend with the overlay to assure conference of the sign onto the face or wall and avoid wrinkling. In this manner, the often replaced advertising material may be formed of an economical medium such as paper, styrene, card stock, and the like. To remove and replace the advertising material, the clear overlay is simply lifted up, the old advertising material removed, and the new advertising material inserted under the clear overlay. The use of the frame-overlay approach also is advantageously used in “pump approach” signs as another embodiment of the invention.

Thus, it is an object of the present invention to provide display apparatus that can hold an advertising sign that is economical to manufacture.

It is also an object of the present invention to provide display apparatus in which the advertising sign is easy to remove and replace.

It is still another object of the present invention to provide advertising apparatus that protects the sign from elements of weather and reduces tampering with the signs.

Thus, the present invention relates to display apparatus comprising a frame having first and second walls for supporting at least one sign and a transparent sign holder having a least a portion thereof removably associated with at least one wall of the frame for covering the advertising sign that, when placed thereunder, is releasably held in place against the wall and can be viewed through the transparent sign holder.

### BRIEF DESCRIPTION OF THE DRAWINGS

These and other more detailed objects of the invention will be more fully described when taken in conjunction with the following Detailed Description of the Drawings in which common elements have like numerals and in which:

FIG. 1 is an isometric view of the preferred embodiment of the bracket or frame for supporting the display sign;

FIG. 2 is an isometric view of the frame of FIG. 1 to which has been attached a removable attachment means such as a first magnetic strip for receiving a second mating magnetic strip located on a clear or transparent sign holder with the sign holder placed on the bracket or frame in superimposed relationship to removably hold an advertising sign thereunder;

FIG. 3 is an isometric view of the frame of FIG. 2 wherein the sign holder, having the mating magnetic strip, may be lifted up at a comer thereof to remove from or insert an advertising sign thereunder;

FIG. 4 is an isometric view of the frame of FIG. 3 illustrating an advertising sign placed between the frame wall and the superimposed clear, or transparent sign holder for viewing by the general public;

FIG. 5 is a front view of a second embodiment of sign holder utilizing aspects of the invention; and

FIG. 6 is a front view similar to FIG. 6 in which a transparent overlay is disposed over a sign insert.

### DETAILED DESCRIPTION OF THE DRAWINGS

FIG. 1 of the drawings is an isometric view of the preferred embodiment of the novel frame or bracket of the present invention. As can be seen, the frame 10 has first and second walls 12 and 14 and, because it is formed of a rigid material such as aluminum, steel, rigid vinyl, high impact plastic, or even a rigid wood product such as pressed board, the walls 12 and 14 may serve as supports for one or more advertising signs placed thereon.

As can be seen, in one preferred embodiment, the frame 10 is formed in a substantially V-shape, with each of the first and second walls 12 and 14 having upper edges 16 spaced from each other, side edges 18 and 22, a common lower edge 20, and an outer border formed by the upper edge 16 the side edges 18 and 22, and the common lower edge 20. Attaching surfaces 24 and 26 extend outwardly from the upper edges 16 of each spaced wall 10 and 12 to enable the frame 10 to be attached to, and hang from, a surface such that said walls hang downwardly and inwardly at an angle for viewing. Any type of well-known fastener, such as a screw, may be inserted through orifices 27 in the attaching surfaces 24 and 26 to fixedly attach the frame 10 to a surface such as a canopy or ceiling over a gas pump area.

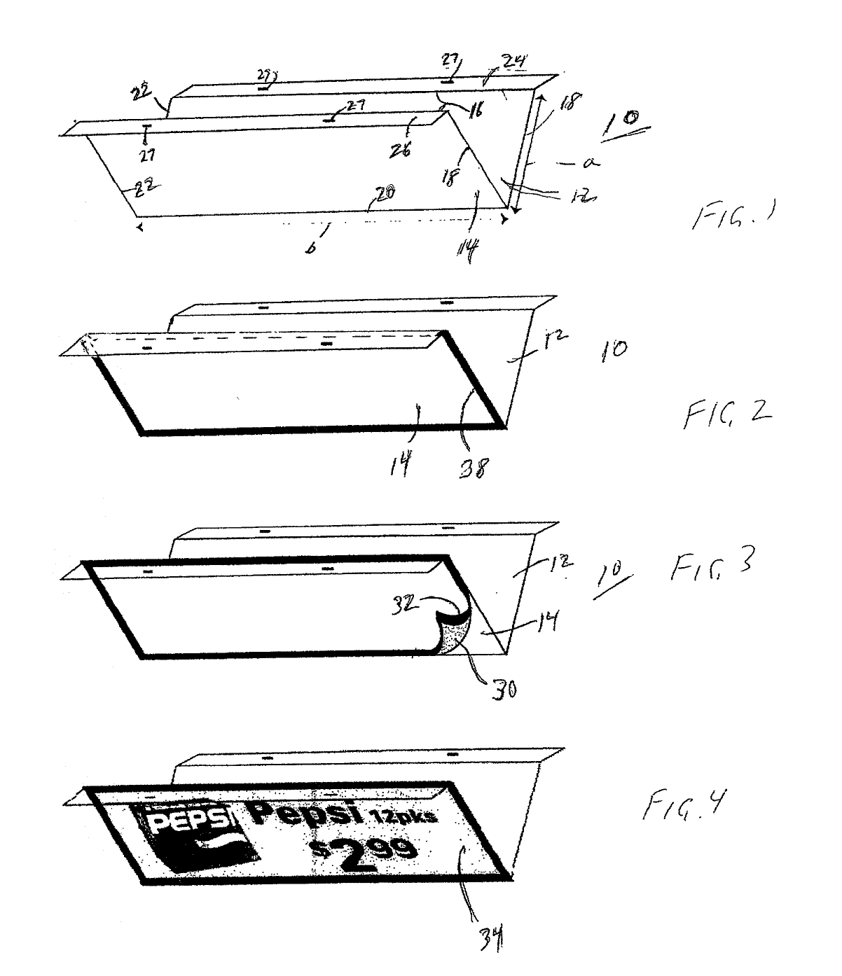

FIG. 2 of the drawings is an isometric view of the preferred embodiment of the bracket of FIG. 1 having an attachment means 28 adhered to at least one of the walls 10 and 12, preferably the border thereof. The preferred attachment means may be a magnetic strip 28, placed at various locations on the wall or, preferably, around the outer border of either or both of the walls 12 and 14 as shown. If, of course, the frame 10 is formed of a ferromagnetic material such as steel, then no magnetic strip 28 would be required as will be explained hereafter.

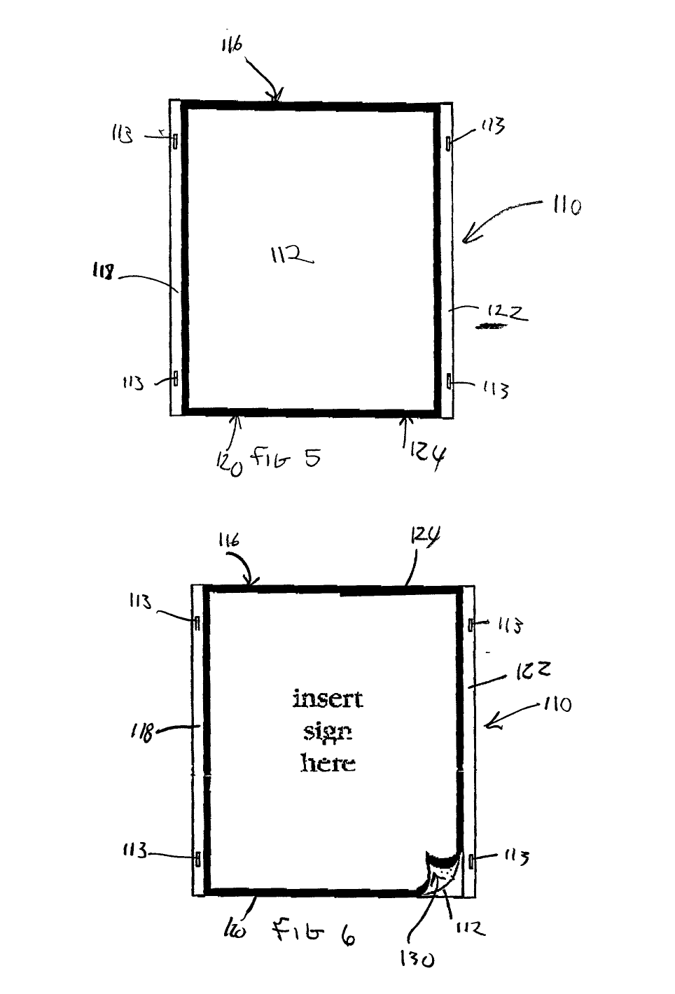

As shown in FIG. 3, a transparent sign cover 30 has at least a portion 32 that has an attachment means removably associated with the wall 14 of frame 10 for covering an advertising sign 34, shown in FIG. 4, and holding it in place so that the advertising sign 34 can be viewed through the transparent sign cover 30.

As can be well understood, the attachment means, or magnetic strip 28, could be placed on a non-ferromagnetic wall 14 at only the side edges 18 and 22 and at the lower common edge 20. The transparent sign holder 30 could then be fixedly attached to the wall 14 at, or along, the upper edge 16 with its magnetic strip 32 in superimposed relationship with the corresponding magnetic portions on the wall 12 (or 14) and then it could be lifted up along the lower common edge 20 and the side edges 18 and 22 (as shown in FIG. 3) such that an advertising sign 34 could be inserted or removed thereunder. If the strips are coextensive with the edges, it fully prevents the wind or elements from entering under the overlay. When the transparent sign holder 30 is lowered back to the wall 14, its magnetic strips 32 along the side edges 18 and 22 and along the lower common edge 20 would be in superimposed relationship with, and adhere to, the magnetic strip 28 correspondingly placed on the wall 14 thus securely holding the advertising sign 34 between the frame wall 14 and the transparent sign holder 30. This arrangement would allow the sign 34 to be viewed through the clear or transparent sign holder 30. In this manner, the information, display or advertising sign is protected from the elements, and from vandalism while allowing the sign 34 to be printed on low cost substrates such as paper, styrene, card stock, and the like that do not require die cutting. This lowers the costs of the inserts substantially and is of considerable benefit to the retailer. Further, with this novel frame construction and with the use of the transparent sign holder, the sign frame does not need to be removed from the ceiling or canopy for changing signs, thus enabling the user to have a simple, fast, and effective means for removing and replacing display signs.

As noted, it will be realized that the magnetic strip may be continuous along the border of either or both the walls 12 or 14 and the transparent sign holder 30 or it may be placed at corresponding spaced intervals along the border of each of them. Further, as stated earlier, if the walls 12 and 14 are totally (or partially) of ferromagnetic material, then only the transparent sign holder 30 needs to have magnetic material thereon inasmuch as that magnetic material would adhere to the ferromagnetic portions of wall 12 or 14.

In an alternative arrangement, the attachment means 28 and 32 may be a hook and loop Velcro® type material combination so that the hook material 28 could be placed on either one of the wall 12 (or 14) and the sign holder 30 and the loop material would be placed on the opposite one of the wall 12 and sign holder 30. The hook and loop material would thus be in removably attached superimposed relationship when the hook and loop material mate. This attachment method would hold the advertising sign 34 securely between the wall 12 (or 14) and the sign holder 30.

In both of the embodiments utilizing either the magnetic strips or the hook and loop combination material as the attachment means, it will be appreciated that the attaching material may be placed at selected locations on the wall(s) and the clear sign holder or placed entirely around the border of both the wall 12 (14) and the transparent sign holder. Thus, the attachment means may be placed on various corresponding superimposed areas on both the wall 12 (14) and the sign holder 30.

If the wall 12 (14) is of ferromagnetic material, then only the sign holder 30 need have magnetic strips on areas in locations as desired. Also, the sign holder 30 could be fixedly attached at the upper edge 16 of the wall 12 (14) and held by the fastening material at other areas as desired.

Although the above described frame is the preferred embodiment of the novel invention, one skilled in the art will readily appreciate that the novel frame could be of a rectangular shape with the two walls 12 and 14 being the opposite sides of a single panel of material, or a double panel if desired, either ferromagnetic or not. This type of frame could be mounted on top of pumps in a pump island with a base formed with the surfaces 24 and 26 as shown in FIG. 1. The frame can be constructed of the same material or materials as discussed earlier. The frame would have first and second walls, one on either side of the single, or double, panel, for supporting an advertising sign. A transparent sign holder would have at least a portion thereof removably associated with at least one of the walls of the frame single panel with an attachment means as described above for covering an advertising sign which, when placed thereunder, is held in place against the wall and can be viewed through the transparent sign holder. The many variations and combinations set forth above for attaching the transparent sign holder to frame 10 can be used in this embodiment.

For example, in FIGS. 5 and 6, there is illustrated a “pump approach” sign wherein a single frame 100 has a wall 112 therein. The wall 112 may be double sided, depending upon how and where the frame 110 is positioned.

The wall 112 may be of materials similar to that of walls 12 and 14 of frame 10. The wall 112 has about its major side portions orifices or slots 113 to receive suitable fastening means (not shown) to semipermanently affix the frame 110 at the end of an island or other viewing location.

The wall 112 has side portions 118 and 122 and top and bottom portions 116 and 120. Attachment means 124 (either in the form of a magnetic strip or hook loop arrangement as for the pump topper) are positioned around the perimeter portions. A transparent sign holder overlay 130 is then removably secured to the frame 110 in the same manner as heretofore described, permitting the actual sign to be removably positioned below the sign holder 130.

Thus, there has been disclosed a novel display apparatus that can be placed on top of a structure such as gasoline pumps at a service station or that may hang down from a structure such as a canopy or ceiling for gasoline pump islands, or may be used at the end or for any display purpose. A transparent sign holder is removably attached to a frame in different manners by self-contained releasable attachment means, such as by magnetic means or by combination hook and loop material, or other self-contained type fastener. By self contained it is meant to exclude fasteners that are completely detached from the overlay and frame. It is also possible that the opening through which the signs are replaced is secured by a combination of Velcro® and magnetic tape. This construction allows the transparent sign holder to be detached from the wall along portions of the sign holder sufficient to allow an advertising sign to be placed thereunder and the clear sign holder is then replaced in superimposed relationship with the wall attachment means to securely hold the advertising sign therebetween thus protecting it from the elements. This construction is not only economical but also allows the sign to be printed on low cost substrates such as paper, styrene, card stock, and the like. Further, it allows a simple operation to remove and replace the advertising sign under the clear sign holder.

While the invention has been disclosed in connection with a preferred embodiment, one skilled in the art will appreciate many other uses and construction of the novel apparatus.

What is claimed is:

1. Display apparatus comprising:
a frame having at least one wall for supporting an informational sign; and a clear sign holder having at least a portion thereof removably associated with said at least one wall of said frame, said covering completing overlay and holding in place, material that, when placed thereunder, can be viewed through the clear sign holder.

2. The display apparatus of claim 1 wherein said frame comprises:
a rigid material having a substantially V-shape with first and second walls, each wall having an upper edge, side edges, a common lower edge, and an outer border; and
an attaching surface extending outwardly from each wall upper edge to enable said frame to be attached to, and hang from, a surface such that said walls hang downwardly and inwardly at an angle for viewing.

3. The display apparatus of claims 1 or 2 further comprising:
releasable self contained attachment means for removably attaching at least a portion of said transparent sign holder to at least one wall of said frame such that said clear sign holder may be lifted at said removable attachable portion to enable advertising material to be removably placed between said clear sign holder and said at least one frame wall.

4. The display apparatus of claim 3 further comprising:
a ferromagnetic material forming at least a portion of at least one of said frame walls; and
at least one magnet placed on a corresponding portion of sign holder for being attracted to said ferromagnetic material so as to securely hold said clear sign holder against said at least one frame wall over said advertising material.

5. The display apparatus of claim 3 wherein said attachment means comprises:
a first magnetic strip placed on at least a portion of said frame wall; and
a second magnetic strip placed on corresponding portions of said clear sign holder such that said magnetic strips are attracted to each other when placed in superimposed relationship and securely hold said clear sign holder to said frame wall over any display material placed thereunder.

6. The display apparatus of claim 5 wherein:
said first magnetic strip is placed around selected portions of said frame wall; and
said second magnetic strip is placed around corresponding portions of said sign holder.

7. The display apparatus of claim 3 wherein:
said sign holder is rectangular in shape having top and bottom edges and first and second side edges forming a border comprising said corresponding portions; and
at least one of said top and bottom edges of said sign holder being hingedly attached to said at least one frame wall such that said one of said top and bottom edges of said sign holder can be lifted up about said hinged edge to enable said display material to be placed thereunder.

8. The display apparatus of claim 3 wherein said attachment means comprises:
a first one of a hook and loop material combination placed on at least a portion of said frame wall; and
the second one of the hook and loop material combination being mounted on opposing corresponding portions of sign holder such that said hook and loop material mate with each other when in superimposed relationship and securely hold said transparent sign holder to said frame wall over said display material.

9. The display apparatus of claim 7 further comprising:
substantially rectangular first and second walls forming said frame;
one of said mating hook and loop material combination being mounted on one of said upper and lower edges and at least one side edge of said at least one of said walls;
said rectangular sign holder being in superimposed mating relationship with one of said first and second walls; and
the other one of said hook and loop material combination being on corresponding edges of said sign holder so as to cause said hook and loop material to removably engage each other to securely hold in place advertising material placed between said wall and said sign holder.

10. The display apparatus of claim 3 wherein said self contained attachment means comprises:
a magnetic strip attached to said at least a portion of the edges of each of said first and second walls, and
a corresponding magnetic strip attached to at least a portion of corresponding edges of said sign holder such that when said display material is placed under the sign holder, the magnetic strip on either of said first and second walls and the magnetic strip on the display holder face are in substantially mutual correspondence to hold said display material securely in place while enabling at least a portion of said sign holder to be selectively separated from said wall magnetic strip to enable display material to be selectively removed and replaced.

11. The display apparatus of claim 3, wherein said self contained attachment means may comprise a combination of hook and loop fastener and a magnetic fastener.
